(19) United States
(12) Patent Application Publication
(10) Pub. No.: US 2014/0067444 A1
(43) Pub. Date: Mar. 6, 2014

(54) BUSINESS PROCESS TRANSFORMATION RECOMMENDATION GENERATION

(71) Applicants: Rama K. T. Akkiraju, Cupertino, CA (US); Mu Qiao, Pittsburgh, PA (US); Aubrey J. Rembert, Chappaqua, NY (US)

(72) Inventors: Rama K. T. Akkiraju, Cupertino, CA (US); Mu Qiao, Pittsburgh, PA (US); Aubrey J. Rembert, Chappaqua, NY (US)

(73) Assignee: INTERNATIONAL BUSINESS MACHINES CORPORATION, Armonk, NY (US)

(21) Appl. No.: 13/618,285

(22) Filed: Sep. 14, 2012

Related U.S. Application Data
(63) Continuation of application No. 13/596,862, filed on Aug. 28, 2012.

(51) Int. Cl. G06Q 10/00

(52) U.S. Cl. 705/7.11

(57) ABSTRACT

Embodiments include a method for managing processes. The method includes collecting, by a processor, data from a plurality of processes. The method also includes recognizing, by the processor, commonality among two or more of the plurality of processes based on the data. The method also includes generating suggestions for transforming one or more of the plurality of processes based on the commonality.

### CROSS-REFERENCE TO RELATED APPLICATIONS AND PRIORITY CLAIM

This application is a continuation of U.S. Non-Provisional application Ser. No. 13/596,862, entitled “BUSINESS PROCESS TRANSFORMATION RECOMMENDATION GENERATION”, filed Aug. 28, 2012, which is incorporated herein by reference in its entirety.

### BACKGROUND

The present disclosure relates to matching similarities among different processes, and in particular to identifying elements in processes having different formats, different levels of granularity of information represented in varying degrees of formalism in different formats and identifying similar elements among such different processes.

An organization or group of organizations may operate based on several business processes, or even several hundred business processes. Similarly, systems may operate based on hundreds of operational processes. Organizations or systems may not have mechanisms for identifying similarities among processes, such as a number of processes that perform the same functions, utilize the same inputs, generate the same outputs, etc. New processes may be initiated or processes may be modified without knowledge of similar processes or modifications in other processes. In addition, different processes may have different levels of formality. Each process may have a different level of information represented, a different structure, or different log data recording the implementation of the process. When an organization or system seeks to modify or add a process, it may not be able to determine portions of existing processes that may be reused, and it may not have access to information regarding how best to generate or improve the process.

### SUMMARY

Exemplary embodiments include a method for managing processes. The method includes collecting, by a processor, data from a plurality of processes. The method also includes recognizing, by the processor, commonality among two or more of the plurality of processes based on the data. The method also includes generating suggestions for transforming one or more of the plurality of processes based on the commonality.

Additional exemplary embodiments include method of managing processes. The method includes collecting, by a processor, data from first processes and second processes stored in memory. The first processes differ from the second processes by at least one of a formality level and a log detail level. The method also includes identifying, by the processor, commonalities among the first processes and second processes. The method also includes organizing, by the processor, the first processes and second stored processes into clusters based on the commonalities.

Further exemplary embodiments include a method for analyzing processes. The method includes receiving, by a processor, a process query and parsing, by the processor, the process query to extract one or more key features from the process query. The method also includes determining a relationship between the process query and one or more stored clusters of processes organized at least according to key features based on the parsing of the process query. The one or more stored clusters is a number of the stored clusters less than all of the stored clusters. The method also includes comparing the one or more key features of the process query with processes in the one or more stored clusters. The method also includes generating a list of one or more stored processes being the most similar to the process query based on the comparing of the one or more key features of the process query with the processes in the one or more stored clusters.

Additional features and advantages are realized through the techniques of the present disclosure. Other embodiments and aspects of the present disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

The subject matter of the disclosure is particularly pointed out and distinctly claimed in the claims at the conclusion of the specification. The forgoing and other features, and advantages of the disclosure are apparent from the following detailed description taken in conjunction with the accompanying drawings in which:

FIG. 1 illustrates a system for managing processes according to one embodiment of the present disclosure;

FIG. 2 illustrates an example of a graphical representation of a process according to one embodiment;

FIG. 3 illustrates a process for organizing processes in clusters according to one embodiment;

FIG. 4 illustrates a process for analyzing processes according to one embodiment;

FIG. 5 illustrates a process for displaying process data according to one embodiment;

FIG. 6A illustrates an example of a group of processes according to one embodiment;

FIG. 6B illustrates an example of displaying process data of the group of processes according to one embodiment;

FIG. 7 illustrates a computer system according to one embodiment; and

FIG. 8 illustrates a computer program product according to one embodiment of the present disclosure.

### DETAILED DESCRIPTION

When an organization, group, or system utilizes multiple different processes, inefficiencies may arise when processes are stored or recorded in different formats or detail, or when the organization, group, or system is incapable of analyzing all of the processes together. Embodiments of the present disclosure relate to managing and analyzing processes by parsing the processes to extract key features, clustering the processes according to the key features, and providing data for transforming one or more of the processes based on the key features.

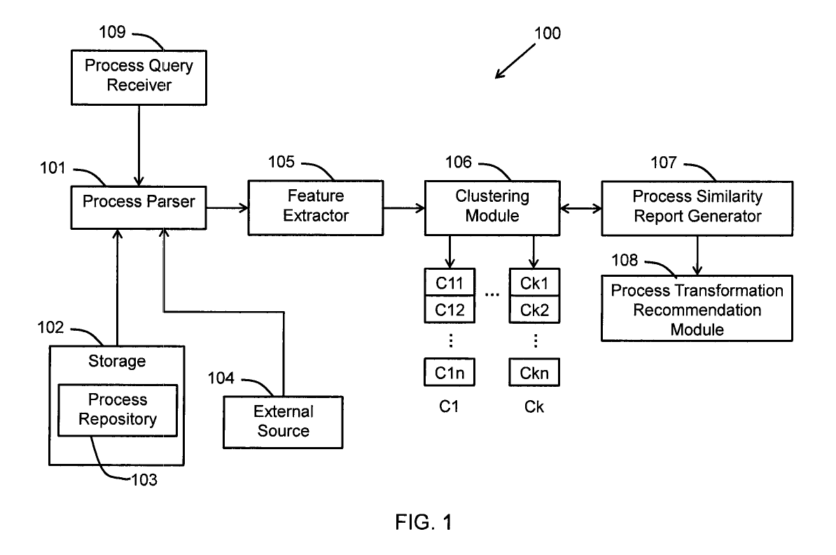

FIG. 1 illustrates a system for managing processes 100 according to one embodiment of the present disclosure. The system 100 includes a process parser 101 that receives process data from storage 102, including a process repository 103, or from an external source 104. Processes according to embodiments of the present disclosure may include business processes, such as management, manufacturing, operational and other processes. Embodiments of the present disclosure also encompass any other type of process that may be tracked, such as software processes. In one embodiment, the process repository is a memory device, database, collection of interconnected memory devices, databases or computers including process data. The process data may include, for example, process context, process structure, process semantics, process data flow, process resources, process execution semantics, and any other process data.

Examples of process context include granularity context, such as classification taxonomy or a scenario in which the process exists or is utilized. Examples of process structure include structures generated in different programs, such as Business Process Model and Notation (BPMN)™, event-driven process chain (EPC), Unified Modeling Language (UML)™, Vizio™, Powerpoint™, or any other structure. Examples of business process semantics include annotations associated with the process, such as publications, tools for viewing, creating, or executing the process, text or labels attached to the structure, or any other semantics. Examples of business process resources include systems that execute the process, people executing the process, types and numbers of resources required to execute the process, etc. Execution semantics include process logs, time taken to execute the process, transactions processed, data fields altered or stored, process origination data, design data, or other process data.

Taking process logs as one example, process logs include any information generated when executing a process. In embodiments of the present disclosure, the system 100 may analyze different processes having different formats and different levels of detail of process logs. Examples of data that make up a process log include an event log, a process name, an action name corresponding to a block, step, or action of the process, an execution timestamp, an event type, such as a start or end, a selection, or an action, and a process instance identifier. In practice, process logs may include one or some of the above data, but most will not include all of the above data. For example, one organization or system may generate process log data only when errors occur during execution of the process and another organization or system may generate process log data at each step of a process. These are examples of different process log detail levels, as described in the present description and recited in the claims, and embodiments of the present disclosure encompass analyzing together the processes having different process log detail levels.

The process parser 101 parses the process data into segments, such as words, phrases, action blocks, structural groups, inputs, outputs, and any other divisions of data. The feature extractor 105 receives the parsed data and identifies key features among the parsed data. In one embodiment, the feature extractor 105 extracts key words from among the process data. In another embodiment, the feature extractor 105 extracts key features from the process data. Key features are defined in the present specification and claims as being features, distinct from individual words described in the process, that have significance in the performance of the process. Key features may be expressly described in the process or may be implied from the description of the process. Key features may be derived from process logs, from graphical representations of the processes, from an alphanumerical description of the process, or from any other data related to the process.

Examples of key features include groups of words in a description of the process, the context in which words are used in a process, a structure of the process, inputs to the process, outputs from the process, resources consumed or generated by the process, key performance indicators measured by the process or used to measure the process, steps in the process, scenarios in which the process is performed, or any other feature relevant to the process having additional meaning from the words alone. In one embodiment, the feature extractor 105 extracts both key words and key features from among the process data.

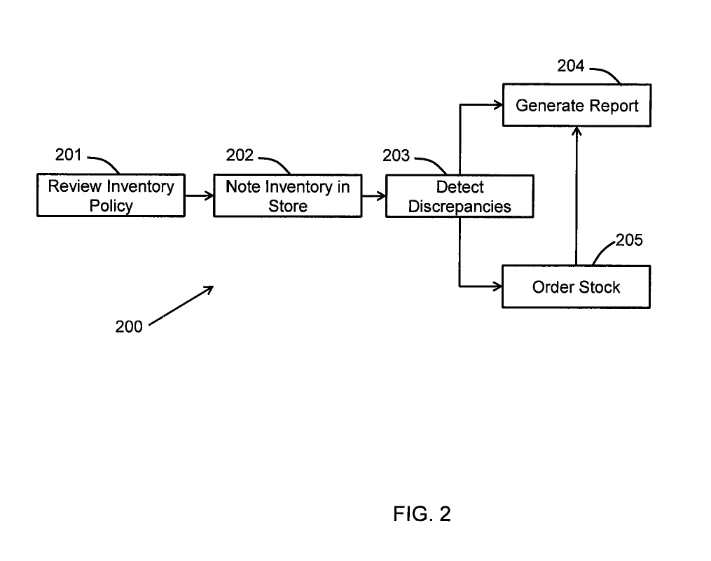

FIG. 2 illustrates an example of a simple process 200 and will be referred to for description purposes. However, it is understood that embodiments of the present disclosure encompass any type of process recorded in any form, such as in graphical form, alphanumeric data form, digital data form, text form, image form, or any other form. Referring to FIG. 2, the process 200 includes action blocks 201, 202, 203, 204, and 205. Block 203 is a decision block from which one of two actions, action 204 or 205, may be selected. While FIG. 2 is directed to a process in a retail industry domain, embodiments of the present disclosure encompass processes in any domain, and across multiple domains.

Block 201 includes a description “review inventory policy.” Block 202 includes a description “note inventory in store.” Block 203 includes a description “detect discrepancies.” Block 204 includes a description “generate report.” Block 205 includes a description “order stock.” In embodiments of the present disclosure, process data having a detailed process log may include multiple portions of memory or multiple entries, each corresponding to a separate description. For example, a plurality of data may be provided under the directory, folder, or heading “record inventory.” Similarly, a plurality of data may be provided under the directory, folder, or heading “generate report.” On the other hand, process data having a less-detailed process log may include little to no data under a heading “record inventory,” may include no specific headings, or may include only a heading “discrepancies detected” corresponding to detected errors or miscalculations detected when performing the process.

In embodiments of the present disclosure, the terms “review,” “record,” “detect,” “generate,” and “order” may be identified as key words. In addition, the words may be sub-categorized as actions taken. In addition, the terms “inventory,’ “discrepancies,” “report” and “stock” may also be identified as key words. The structure of the process, the results (an order and/or a report), the actions taken (e.g. “review inventory,” “record inventory,” “detect discrepancies,” etc.), the purpose of the process (e.g. “managing inventory” or “keeping up inventory”), and other data may be identified as key features of the process.

Referring again to FIG. 1, a clustering module 106 receives the key features and optionally the key words from the feature extractor 105, identifies commonalities among the plurality of processes, and organizes the plurality of processes in clusters C1 to Ck according to the commonalities. In one embodiment, the clustering module 106 determines topics corresponding to the processes and generates the clusters based on the determined topics. Each cluster may include multiple sub-clusters, such as sub-clusters C11 to C1n and Ck1 to Ckn. The clusters C1 to Ck may be organized according to one metric, such as key words, and the sub-clusters C11 to Ckn may be organized according to another metric, such as structure and semantic content, where semantic content includes meaning represented in a form other than key words (e.g., structure, purpose, themes, scenarios in which the process is implemented, phrases or groups of words, inputs to/outputs from the process, etc.). In one embodiment, the clustering module 106 organizes the processes first according to key words found in the process data (such as “inventory,” “report,” and “order” in the example of FIG. 2). Then, the clustering module 106 organizes the processes according to key features, such as process structure (i.e. the sequence of actions performed in the process) and semantic similarity among the processes.

A process similarity report generator 107 communicates with the clustering module 106 to identify processes that are similar to each other, such as processes clustered together, and generates a report. In one embodiment, the report is generated on a display device, such as an electronic display device (e.g., a computer monitor), a paper display device (e.g., a printer), or any other display device. The report may provide graphical data to illustrate the detected similarities among the processes. For example, multiple processes may be displayed, each as a series of connected nodes, and the nodes having the greatest level of similarity may be colored the same, shaded the same, or otherwise graphically identified in the same manner that is distinguished from other nodes of the processes. In some embodiments, processes may not have enough information to be represented in graphical format. Accordingly, the processes may be represented by text such as key words and groups of key words and features.

A process transformation recommendation module 108 may receive the data identifying the most similar processes and may provide recommendations for transforming one or more processes. For example, it may be determined that a step XY is performed most often among all of the processes. Therefore, the process transformation recommendation module may suggest improving the efficiency of step XY to improve the efficiency of the greatest number of processes. As another example, it may be determined based on process log data that step XY increases in efficiency when it follows step XX. Accordingly, the process transformation recommendation module may suggest inserting step XX into one or more of the displayed processes prior to step XY. Although two examples of process transformation recommendations have been provided, it is understood that embodiments of the present disclosure encompass any recommendations based on analysis of the commonalities of the plurality of processes and the key features among the processes.

In one embodiment, a process query receiver 109 receives a process query which may include one or more key words, phrases, symbols, graphical representations for analyzing or comparing processes, or may be a process itself. The process query receiver 109 may be a user input, such as a keyboard, a device interface to receive data from an external device, or any other type of receiver for receiving process query data. The process parser 101 may parse the query, the feature extractor 105 may extract key words and key features from the query, and the clustering module 106 may identify one or more clusters C1 to Ck, or C11 to Ckn of processes that most-closely match the process query.

In one embodiment, the clustering module 106 determines one or more clusters from among the clusters C11 to Ckn that most closely match the extracted features of the query. The one or more clusters may be a sub-set of all of the clusters. The clustering module 106 may then compare the extracted features of the query with the processes within the sub-set of clusters to identify one or more of the processes within the sub-set of clusters that most-closely match the process query.

The process similarity report generator 107 may generate a similarity report, as discussed above. For example, the process similarity report generator 107 may generate a depiction of a process based on the process query and may further depict one or more processes from among the clusters C1 to Ck and sub-clusters C11 to Ckn that most closely match the process based on the process query. In another embodiment, the process similarity report generator 107 may generate a depiction of one or more processes from among the clusters C1 to Ck and sub-clusters C11 to Ckn that most closely match the process based on the process query, without depicting a process corresponding to the process query. In one embodiment, the process similarity report generator 107 may visually depict two or more processes that are most-similar to the process query according to a similarity ranking. In embodiments of the present disclosure, the depiction of processes may include a textual depiction, a graphical depiction, or any other type of depiction including, for example, audible depictions or any other means of conveying information.

The process transformation recommendation module 108 may provide recommendations for transforming either a process indicated by the process query, or one or more of the processes corresponding to the clusters C11 to Ckn that most-closely match the process query.

Although one configuration of a system for managing processes 100 is illustrated in FIG. 1, it is understood that the system 100 may have any configuration capable of receiving processes and/or queries, parsing the processes and/or queries, extracting key words and/or features, clustering the processes based on extracted key words and/or features, identifying similarities among processes and queries, and generating reports and recommendations based on the extracted key features and similarities. For example, although the process query receiver 109 is illustrated as providing a query to the same process parser 101 as the storage 102, in some embodiments, the process query receiver 109 may have an independent parser and feature extractor separate from the stored or provided processes.

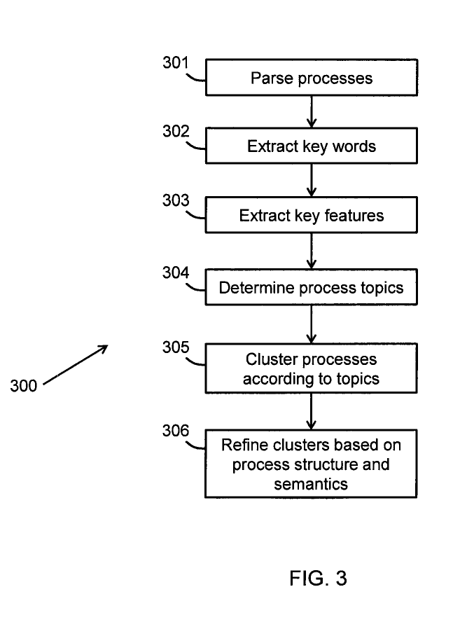

FIG. 3 illustrates a process 300 of managing processes according to one embodiment. In block 301, multiple processes are parsed. The processes may have different formats, different levels of descriptive detail, different levels of log data detail, different structures, may be represented with different graphical representations, or may have any other differences between the processes. In block 302, key words are identified among the parsed data. Key words are identified and organized based only on the word and not on additional meaning or context of the word.

In block 303, key features are identified among the parsed data. Key features are defined in the present specification and claims as being features, distinct from individual words described in the process, that have significance in the performance of the process. Key features may be expressly described in the process or may be implied from the description of the process. For example, if a process describes a step of making a substance “X”, key words may include “make” and “X.” Key features may include non-described substances required to make substance “X”, such as “substance Y” and “substance Z.” Key features may be derived from process logs, from graphical representations of the processes, from an alphanumerical description of the process, or from any other data related to the process.

Examples of key features include groups of words in a description of the process, the context in which words are used in a process, a structure of the process, inputs to the process, outputs from the process, resources consumed or generated by the process, key performance indicators measured by the process or used to measure the process, steps in the process, scenarios in which the process is performed, or any other feature relevant to the process having additional meaning from the words alone.

For example, with reference to the process illustrated in FIG. 2, the words “inventory,” “report,” and “stock” may be key words. Key features may provide context for the key words and may include terms such as “record inventory,” “generate report,” and “order stock.” “Record inventory” describes a step performed and a result of the process (e.g., a record of the inventory). Similarly, “generate report” describes an output of the process (e.g., a report), and “order stock” describes a result of the process (e.g. additional stock ordered). In addition, any programs or systems required to perform the process may be provided as key features. For example, if in a given organization a program “Report Gen” is used to generate reports, then the term “Report Gen” may be a key feature of the process, even though it may not be expressly described in the process description.

In block 304, process topics are determined. Topics may be determined based on the parsed key words and key features. For example, topics of the example process 200 of FIG. 2 may include “maintaining inventory,” “detecting discrepancies,” “requesting materials,” “generating reports,” etc. In block 305, the processes may be clustered according to topics. For example, the example of FIG. 2 may be added to clusters having topics “maintaining inventory,” “detecting discrepancies,” “requesting materials,” “generating reports,” etc.

In block 306, the clusters may be further refined into subcategories based on process structure and semantics determined by the key words and key features. For example, the example process 200 of FIG. 2 may be subcategorized into a sub-category for process structures in which one action that follows from a selection node leads to another action that follows from the selection node. The example process 200 may further be subcategorized based on generating inventory reports, ordering inventory, ordering inventory after reviewing the inventory, or any other context or semantic content of the process.

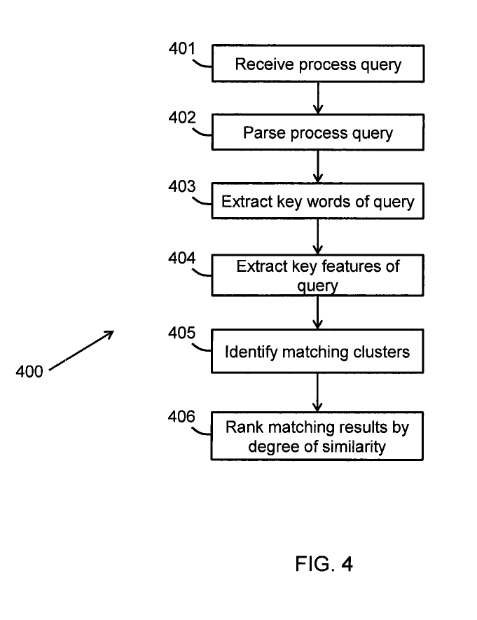

FIG. 4 illustrates a process 400 for providing results to a process query according to one embodiment. In block 401, a process query is received. The process query may include one or more words, phrases, graphical representations of processes, symbols, a process itself, or any other data that may be used to retrieve process information.

In block 402, the process query is parsed. In block 403, key words are extracted. Key words are identified and organized based only on the word and may not rely on additional meaning or context of the word. In block 404, key features are extracted. Key features, as described previously, are defined in the present specification and claims as being features, distinct from only words described in the process, that have significance in the performance of the process.

In block 405, clusters of stored processes are identified that have similarities to the process query based on the extracted key words and key features of the process query. The clusters may be organized according to determined topics, key words and key features, and the key words and key features extracted from the process query may be compared with the cluster organization to identify clusters and processes in the clusters that are most-closely-related to the process query. In block 406, the matched results are ranked based on a degree of similarity to the process query.

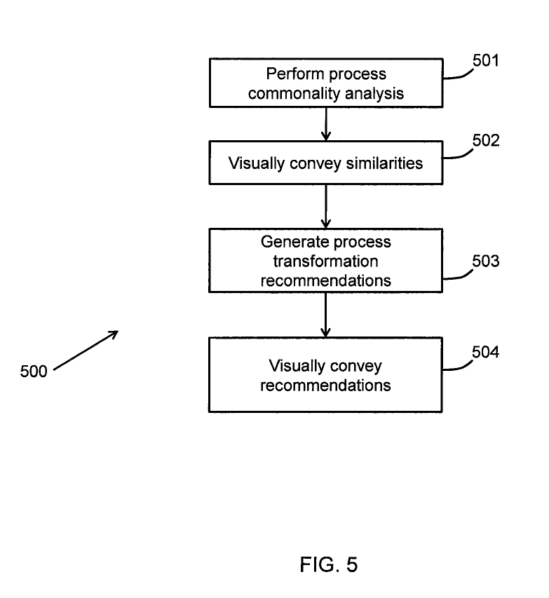

FIG. 5 illustrates a method 500 for visually providing feedback based on managing processes according to one embodiment. In block 501, a process commonality analysis is performed. For example, the process 300 of FIG. 3 may be performed to organized stored processes into clusters based on identified commonalities among the processes, and the process 400 of FIG. 4 may be performed to determine which stored clusters are most closely related to a process query.

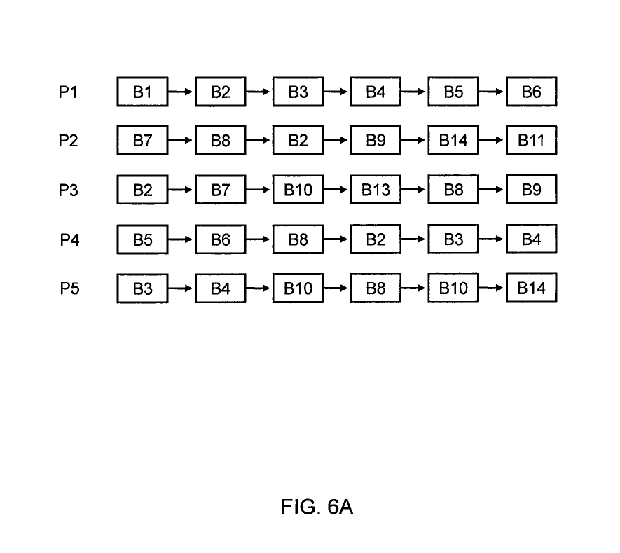

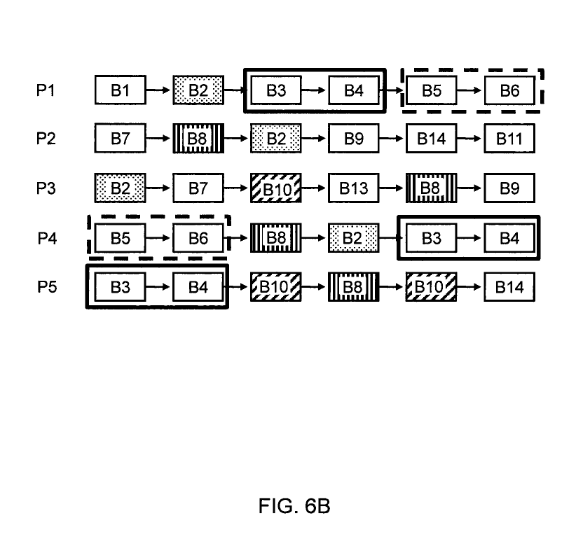

In block 502, similarities among the processes may be visually conveyed to a user or device. For example, the similarities may be marked with a particular graphic, symbol, alphanumerical identifier, or any other identifier on an electronic display, printing medium, or any other display apparatus. FIGS. 6A and 6B illustrate an example of visually conveying similarities among processes according to one embodiment.

In FIG. 6A, five processes P1 to P5 are illustrated, each having a same structure of six sequential action blocks. The content of the action blocks, or the actions performed when executing the block, varies from one process to the next, as indicated by distinct labels B1 through B14, where same labels represent a same action performed. Although various boxes are provided with the same label in FIGS. 6A and 6B, it is understood that embodiments of the present disclosure encompass comparison of blocks having different levels of detail or different description terms that may be determined to be the same based on analysis. For example, the block B3 of process P1 may result from a graphical representation of a process in which the block has a description “record inventory data,” and the block B3 of process P5 may correspond to process logs in which no graphical representation of a process is found, but in which an inventory data record is found. Based on key word and key feature analysis, it may be determined that the process data provided in different formats and with different levels of specificity corresponds to a same action block B3 in which inventory data is recorded.

In embodiments of the present disclosure, the processes P1 to P5 may be based on processes of varying formats, recorded in varying degrees of specificity, supported by varying levels of process log data, etc. The processes P1 to P5 may be stored processes that have been clustered together based on a topical similarity. The processes P1 to P5 may be derived from one organization or system or from multiple organizations or systems. In addition, one or more of the processes P1 to P5 may be based on a process query received from a user, device or system for comparison with the other processes P1 to P5.

In FIG. 6B, graphics are added to a display of the graphical representations of the processes to more quickly identify similarities among the processes. For example, when two or more blocks are executed in a same order in multiple processes, a box is drawn around the blocks. In processes P1, P4 and P5, a solid box is drawn around blocks B3 and B4 and in processes P1 and P4 a dashed box is drawn around blocks B5 and B6. In addition, shading is added to blocks to indicate a repetition of the most-common blocks among the processes, such as shading of blocks B2, diagonal lines of blocks B10, and vertical lines of blocks B8.

By viewing the patterns, a user may quickly see that processes P1 and P4 include the most commonalities among all of the processes, including the most blocks executed in the same order and the most total blocks in common. While black and white patterns are provided in FIG. 6B for purposes of description, it is understood that any patterns, shading, fills, shapes, or other identifiers may be used to visually represent commonalities. For example, blocks that are executed in the same order may be surrounded by a box of a particular color or may be shaded in a particular color, and the shading and stripes represented in FIG. 6B may be replaced by respective colors.

Referring again to FIG. 5, in block 503, process transformation recommendations are generated. The transformations may be recommended based on data obtained in the process commonality analysis of block 501. For example, the recommendations may be based on key features extracted from a process description, a graphical representation of a process, process logs, or any other analyzed data. Transformation recommendations may include recommendations for adding steps, omitting steps, rearranging steps, improving steps, or performing any other transformation of a process. For example, referring to FIG. 6B, a user may request recommendations for most-efficiently improving customer satisfaction in an organization that practices all of the processes P1 through P5. Based on process log data, external survey data, or any other provided data, it may be determined that blocks B1, B7 and B8 most increase customer satisfaction. By analyzing the commonalities among the processes, it may be determined that block B8 is the most-repeated block among all of the processes, and therefore improving the execution of block B8 would most likely provide the greatest increase in customer satisfaction across the entire organization.

In another example, analyzed process log data may indicate that block B2 increases in efficiency when it follows block B8, and a recommendation may be provided for adding block B8 to process P1 prior to block B2. A visual representation of the block B8, such as having a translucent coloration, may be shown preceding block B2 to indicate the recommendation. In another example, it may be determined that repeating block B10 is unnecessary in process P5 and a recommendation may be provided to omit one of the blocks B10. A visual representation of the recommendation may include shading one of the blocks B10 in red. The foregoing are provided only as examples of recommendations that may be provided for transforming processes and providing a graphical representation of the transformation. However, it is understood that embodiments of the present disclosure encompass any recommendations and visual representations of recommendations based on key words, key features, and analysis of commonalities among processes.

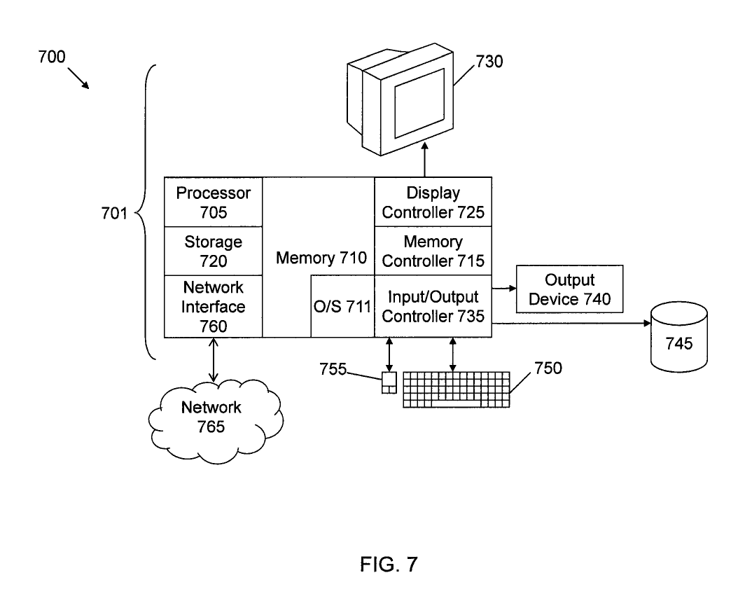

FIG. 7 illustrates a block diagram of a computer system 700 according to an embodiment of the present disclosure. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 700 therefore may include general-purpose computer or mainframe 701.

In an exemplary embodiment, in terms of hardware architecture, as shown in FIG. 7, the computer 701 includes a one or more processors 705, memory 710 coupled to a memory controller 715, and one or more input and/or output (I/O) devices 740, 745 (or peripherals) that are communicatively coupled via a local input/output controller 735. The input/output controller 735 can be, for example, one or more buses or other wired or wireless connections, as is known in the art. The input/output controller 735 may have additional elements, which are omitted for simplicity in description, such as controllers, buffers (caches), drivers, repeaters, and receivers, to enable communications. Further, the local interface may include address, control, and/or data connections to enable appropriate communications among the aforementioned components. The input/output controller 735 may access the output devices 740 and 745.

The processor 705 is a hardware device for executing software, particularly that stored in storage 720, such as cache storage, or memory 710. The processor 705 can be any custom made or commercially available processor, a central processing unit (CPU), an auxiliary processor among several processors associated with the computer 701, a semiconductor based microprocessor (in the form of a microchip or chip set), a macroprocessor, or generally any device for executing instructions.

The memory 710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, and/or other types of storage media. Note that the memory 710 can have a distributed architecture, where various components are situated remote from one another, but can be accessed by the processor 705.

The instructions in memory 710 may include one or more separate programs, each of which comprises an ordered listing of executable instructions for implementing logical functions. In the example of FIG. 7, the instructions in the memory 710 include a suitable operating system (O/S) 711. The operating system 711 essentially controls the execution of other computer programs and provides scheduling, input-output control, file and data management, memory management, and communication control and related services.

In an exemplary embodiment, a conventional keyboard 750 and mouse 755 can be coupled to the input/output controller 735. Other output devices such as the I/O devices 740, 745 may include input devices, for example, but not limited to a printer, a scanner, microphone, and the like. Finally, the I/O devices 740, 745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 700 can further include a display controller 725 coupled to a display 730. In an exemplary embodiment, the system 700 can further include a network interface 760 for coupling to a network 765. The network 765 can be any type of network, such as an IP-based network for communication between the computer 701 and any external server, client and the like via a broadband connection, an optical fiber network, or any other type of network.

The network 765 transmits and receives data between the computer 701 and external systems. In an exemplary embodiment, network 765 can be a managed IP network administered by a service provider. The network 765 may be implemented in a wireless fashion, e.g., using wireless protocols and technologies, such as WiFi, WiMax, etc. The network 765 can also be a packet-switched network such as a local area network, wide area network, metropolitan area network, Internet network, or other similar type of network environment. The network 765 may be a fixed wireless network, a wireless local area network (LAN), a wireless wide area network (WAN) a personal area network (PAN), a virtual private network (VPN), intranet or other suitable network system and includes equipment for receiving and transmitting signals.

When the computer 701 is in operation, the processor 705 is configured to execute instructions stored within the memory 710, to communicate data to and from the memory 710, and to generally control operations of the computer 701 pursuant to the instructions.

In an exemplary embodiment, the methods of managing processes described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In embodiments of the present disclosure, the process management system may utilize hardware and software within the computer system 700, including memory 710 or output devices 740 and 745 for storing process data in repositories, the processor 705 for analyzing process data, and the display controller 725 for converting stored data into data for displaying graphical representations of the process data, the display 730 for providing visual displays of commonalities among processes and recommendations for transforming processes. In addition, the keyboard 750 and mouse 755 may receive user input regarding processes and effects and process query data.

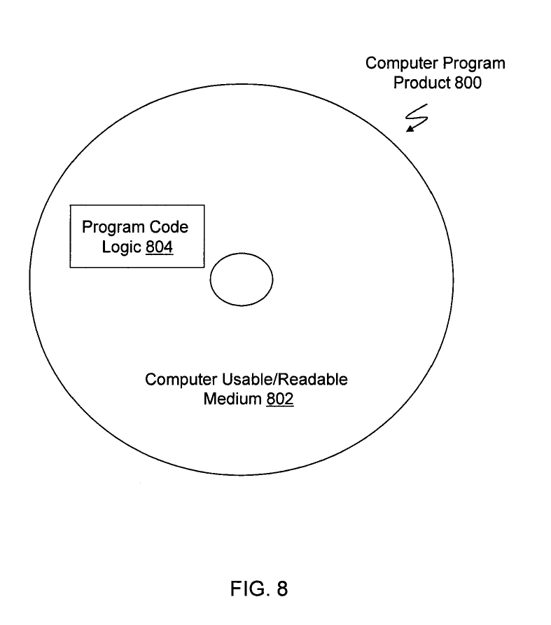

As described above, embodiments can be embodied in the form of computer-implemented processes and apparatuses for practicing those processes. An embodiment may include a computer program product 800 as depicted in FIG. 8 on a computer readable/usable medium 802 with computer program code logic 804 containing instructions embodied in tangible media as an article of manufacture. Exemplary articles of manufacture for computer readable/usable medium 802 may include floppy diskettes, CD-ROMs, hard drives, universal serial bus (USB) flash drives, or any other computer-readable storage medium, wherein, when the computer program code logic 804 is loaded into and executed by a computer, the computer becomes an apparatus for practicing the embodiments. Embodiments include computer program code logic 804, for example, whether stored in a storage medium, loaded into and/or executed by a computer, or transmitted over some transmission medium, such as over electrical wiring or cabling, through fiber optics, or via electromagnetic radiation, wherein, when the computer program code logic 804 is loaded into and executed by a computer, the computer becomes an apparatus for practicing the embodiments. When implemented on a general-purpose microprocessor, the computer program code logic 804 segments configure the microprocessor to create specific logic circuits.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention to the particular embodiments described. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosed embodiments. Many modifications and variations will be apparent to those of ordinary skill in the art without departing from the scope and spirit of the embodiments of the present disclosure.

In embodiments of the present disclosure, effects of modifications to standard business processes may be estimated based on stored prior modifications to the standard business processes. In addition, proposed modifications to standard business processes may be provided based on desired effects provided by an entity. Accordingly, past customizations to processes may be utilized to more efficiently design and select future customizations. In addition, guidance may be provided to entities regarding the likely effects of desired changes to processes implemented by the entities. Examples of processes may include business financial or operational processes, software or electrical processes and manufacturing processes. However, it is understood that embodiments of the present disclosure encompass any process that may be represented by data in a graphical form, stored and analyzed.

While preferred embodiments have been described above, it will be understood that those skilled in the art, both now and in the future, may make various improvements and enhancements which fall within the scope of the claims which follow.

1. A method for managing processes, comprising:
collecting, by a processor, data from a plurality of processes;
recognizing, by the processor, commonality among two or more of the plurality of processes based on the data, the two or more of the plurality of processes having at least one of a difference in a formality level and a log-detail level; and
generating suggestions for transforming one or more of the plurality of processes based on the commonality.

2. The method of claim 1, wherein the data includes graphical representations of business processes for completing operations of the business.

3. The method of claim 2, wherein the graphical representations include interconnected nodes representing actions performed to complete the process, the method further comprising:
identifying most-commonly-occurring nodes among the plurality of processes.

4. The method of claim 1, wherein the plurality of processes includes first processes and second processes, the first processes differing from the second processes by at least one of a formality level and a log-detail level.

5. The method of claim 1, wherein recognizing commonality among the plurality of processes includes forming clusters of processes, each cluster corresponding to a recognized commonality among processes in the cluster.

6. The method of claim 1, wherein recognizing commonality among the plurality of processes includes extracting key words from the plurality of processes and extracting key features, the key features including at least one of a description, an order of execution of steps, a structure of the plurality of processes, key performance indicators, inputs to perform the steps, outputs resulting from performance of the steps, and resources used in performing the steps.

7. The method of claim 1, wherein generating suggestions for transforming the one or more processes includes visually conveying the recognized commonalities among two or more of the plurality of processes.

8. The method of claim 7, wherein visually conveying the recognized commonalities includes displaying simultaneously graphical representations of the two or more of the plurality of processes with at least one of patterns, colors, and shades indicating one or more of the recognized commonalities.

9. The method of claim 1, wherein generating suggestions for transforming the one or more processes includes visually conveying recommendations for transforming the one or more processes.

10.-20. (canceled)

21. The method of claim 1, wherein generating suggestions for transforming the one or more processes includes identifying, by analyzing the two or more processes, a process transformation to increase an efficiency of the one or more processes.

22. The method of claim 21, wherein the process transformation includes one of inserting a step at a predetermined location in the one or more processes and increasing an efficiency of a step that is used most often by the two or more processes.

23. A method for managing processes, comprising:
collecting, by a processor, data from a plurality of processes;
recognizing, by the processor, commonality among two or more of the plurality of processes based on the data;
organizing the two or more of the plurality of processes into clusters based on the commonality, and
generating suggestions for transforming one or more of the plurality of processes based on the commonality,
wherein the organizing the two or more of the plurality of processes includes organizing the two or more of the plurality of processes into clusters based on key words and further organizing the two or more of the plurality of processes into sub-clusters within the clusters based on at least one of structure and semantic content other than key words.

24. The method of claim 23, wherein generating suggestions for transforming the one or more processes includes visually conveying recommendations for transforming the one or more processes by visually displaying two or more processes in a cluster simultaneously and providing graphical data, including at least one of a color, pattern and shading, to indicate similarities among the two or more processes.

25. A method for managing processes, comprising:
collecting, by a processor, data from a plurality of processes;
recognizing, by the processor, commonality among two or more of the plurality of processes based on the data, the two or more processes corresponding to executed processes recorded by process logs, and the two or more processes having different process log detail levels;
organizing the two or more of the plurality of processes into clusters based on the commonality, and
generating suggestions for transforming one or more of the plurality of processes based on the commonality.
